(19) United States
(12) Patent Application Publication
(10) Pub. No.: US 2005/0200080 A1
(43) Pub. Date: Sep. 15, 2005

(54) Seal for a turbine engine

(75) Inventors: Sam Baghdadi, Palm Beach Gardens, FL (US); Robert W. Sunshine, Hobe Sound, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/797,452

(22) Filed: Mar. 10, 2004

(51) Int. Cl. F16J 15/40

(52) U.S. Cl. 277/409

(57) ABSTRACT

A seal usable in a turbine engine for sealing a high pressure gas region from a low pressure gas region. The seal seals gaps between a rotatable body and a stationary body by creating forces opposing flow from the high pressure region to the low pressure region. During turbine engine operation, the seal creates aerodynamic forces that substantially prevents leakage of gases from a high pressure region to a low pressure region. The seal may be formed from a plurality of blades aligned in one or more rows and extending from a rotatable body towards a stationary body of the turbine engine to be in close proximity to the stationary body. The seal may also include a plurality of blades aligned in one or more rows and extending from the stationary body towards the rotatable body to be within close proximity of a surface of the rotatable body.

### FIELD OF THE INVENTION

This invention is directed generally to seals, and more particularly, to seals usable between a rotatable body and a hollow body in a turbine engine.

### BACKGROUND

In the art of turbine engine design, the need often exists to seal connections between adjacent turbine components in order to separate fluids and to maintain a turbine's efficiency. More particularly, a seal is often needed to separate high pressure regions from low pressure regions between components whereby one of the components is stationary and an adjacent component rotates. For instance, a common location for separating high pressure compressor gases and low pressure gases is between a rotor assembly, which rotates, and a stator assembly, which remains relatively stationary during operation of a turbine engine.

As shown in FIG. 1, a conventional seal used between rotatable and stationary components of a turbine engine comprised of a labyrinth seal having a plurality of ridges extending from a rotatable body. The ridges are sized to initially contact the opposing stationary body and to cut grooves into the stationary body. As the rotatable body rotates during use, the ridges simply rotate within the grooves. The ridges prevent some gases, but not all gases, from passing between the gap created between the ridges and the grooves. Thus, the labyrinth seal is susceptible to leakage and results in inefficiencies in the turbine engine in which the seal is used. Thus, a need exists for a turbine seal capable of sealing openings between rotatable and stationary turbine components.

### SUMMARY OF THE INVENTION

This invention relates to a seal for sealing a high pressure region of gases from a low pressure region of gases in a turbine engine and particularly, usable between a stationary component of the turbine engine, such as, but not limited to a stator, and a rotatable component of the turbine engine, such as, but not limited to a rotor. The seal may be formed from a plurality of blades extending radially from a rotatable body and generally forming at least one row of blades. The seal may also include a plurality of blades extending radially from a stationary body towards the rotatable body and may generally form at least one row of blades. The plurality of blades extending radially from the stationary body may be positioned proximate to the plurality of blades extending from the rotatable body and aligned in a nonparallel configuration with the plurality of blades extending from the rotatable body.

The blades extending from the rotatable body may be aligned relative to a rotational axis of the rotatable body such that downstream edges of the blades may be advanced relative to upstream edges of the blades in relation to a direction of rotation of the rotatable body. In this configuration, rotation of the rotatable body produces aerodynamic forces opposing the leakage flow, which tend to drive gases toward the blades extending from the stationary body. However, the plurality of blades extending from the stationary body may be aligned generally opposite to the blades extending from the rotatable body. This configuration of blades creates aerodynamic forces opposing the leakage flow; thus, increasing the resistance to leakage and reducing the amount of flow that leaks past the arrangement to any desired level. In at least one embodiment, these aerodynamic forces substantially prevent a gas from passing from a high pressure region to a low pressure region by flowing between the rotatable and stationary bodies. This configuration is advantageous in that the configuration substantially prevents leakage of gases from a high pressure region to a low pressure region without using movable components that are susceptible to wear from contacting adjacent stationary components. In addition, this configuration is advantageous in that the configuration substantially prevents leakage of gases past the seal. These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a conventional seal usable in a conventional turbine engine.

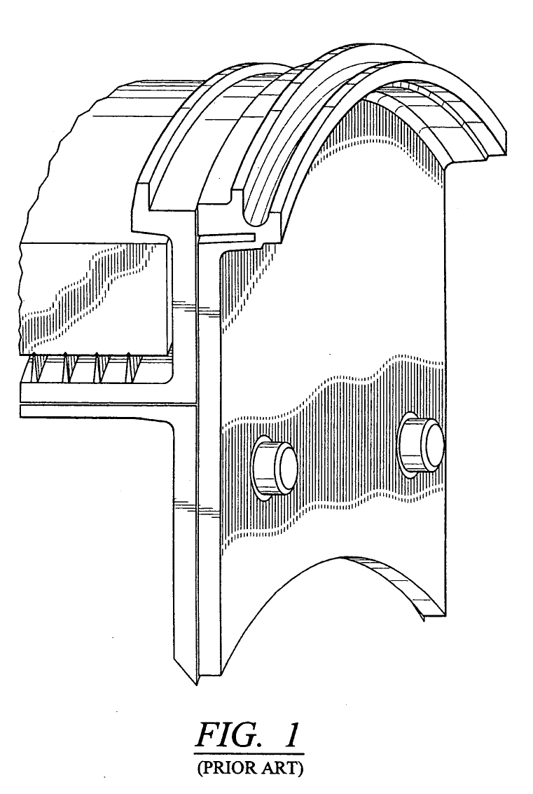

FIG. 2 is a perspective view of a rotor and stationary portions of a turbine engine having a seal with aspects of this invention.

### DETAILED DESCRIPTION OF THE INVENTION

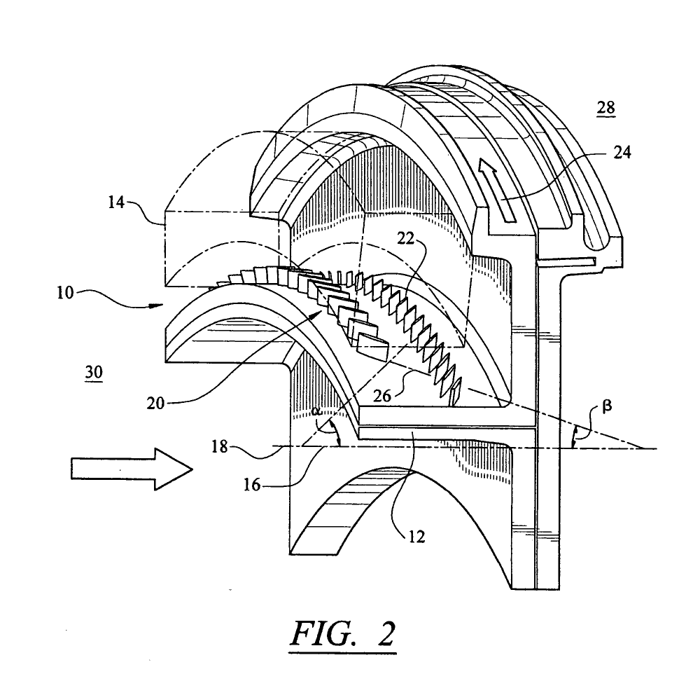

As shown in FIG. 2, this invention is directed to a seal 10 usable in turbine engines. The seal 10 may be used to form a seal between a rotatable body 12 and a stationary body 14 in a turbine engine. The seal 10 creates a reverse flow that is counter to the flow from a high pressure region 30 to a low pressure region 28. The reverse flow substantially prevents gases from flowing from the high pressure region 30 of a turbine engine to a low pressure region 28 of the turbine engine between rotatable and stationary components of the turbine engine. In at least one embodiment, the rotatable body 12 may be, but is not limited to, a rotor assembly of a turbine engine, and the stationary body 14 may be, but is not limited to, a stator of a turbine engine. The seal 10 is not limited to being used only between a rotor assembly and a stator, but may be used in other locations in a turbine engine as well. For instance, the seal 10 may be used in turbine vane housings, compressor stator wells, thrust pistons, bearing compartments, shaft seals and any location where labyrinth seals, brush seals, or leaf seals are currently used. In addition, the seal 10 may also be used in other mechanical devices such as steam turbines, rocket engines, etc.

The seal 10 may be formed from a plurality of blades 16 that extend radially from the rotatable body 12. The blades 16 may form one or more rows, as shown in FIG. 2. While only a single row of blades 16 is shown in FIG. 2, a plurality of rows may be used in other embodiments. The blades 16 may also be aligned at an angle a of between about 1 degrees and about 89 degrees relative to a rotational axis 18 of the rotatable body 12. In at least one embodiment, the blades 16 may be aligned at an angle of about 60 degrees relative to the rotational axis. As shown in FIG. 2, the blades 16, in at least one embodiment, may be substantially parallel to each other. The blades 16 may extend to be in close proximity with the stationary body 14. For instance, the blades 16 may extend from the rotatable body 12 to be within about 0.6 millimeters radially from the stationary body 14.

The seal 10 also includes a plurality of blades 20 extending from the stationary body 14 towards the rotatable body 12. The blades 20 may form a single row, as shown in FIG. 2, or a plurality of rows. The blades 20 may also be aligned at an angle β of between about 1 degrees and about 89 degrees relative to a rotational axis 18 of the rotatable body 12. In at least one embodiment, the blades 16 may aligned at an angle of about 60 degrees relative to the rotational axis. The angles α and β are measured from the rotational axis 18. However, the blades 16 and 20 are not parallel as the angle α is measured oppositely from the angle β. In at least one embodiment, the plurality of blades 16 may be generally orthogonal to the plurality of blades 20. The blades 20 extend from the stationary body 14 toward the rotatable body 12, and the blades 20 may extend to be about 0.6 millimeters radially from the rotatable body 12. It is desirable to minimize the axial distance between the plurality of stationary and rotating blades 20 and 16 as that tends to minimize the leakage level, which is a typical design goal. However, the seal 10 can be effective even with fairly large axial gaps.

As shown in FIG. 2, each blade 16 is positioned on the rotatable body 12 such that a downstream edge 22 of each blade of the plurality of blades 16 is advanced in a direction of rotation, as shown by arrow 24, more than the upstream edges 26 of the blades 20. During operation, the row of blades 16 attached to the rotatable body 12 rotate relative to the rotational axis 18. This motion produces a force in the direction to oppose gas flow from the high pressure region 30 of the turbine engine toward the low pressure region 28. The rotational motion of the rotatable body 12 and the blades 16 produces forces opposing leakage from the high pressure region 30 to the low pressure region 28. Thus, the net flow of air past the seal 10 from the high pressure region 30 to the low pressure region 28 is between about zero to a small amount of flow. The design can be adjusted to allow any desired amount of leakage.

The foregoing is provided for purposes of illustrating, explaining, and describing embodiments of this invention. Modifications and adaptations to these embodiments will be apparent to those skilled in the art and may be made without departing from the scope or spirit of this invention.

1. A seal, comprising:
a plurality of blades extending radially from a rotatable body and generally forming at least one row of blades;
a plurality of blades extending radially from a stationary body towards the rotatable body and generally forming at least one row of blades; and
wherein the plurality of blades extending radially from a stationary body are positioned proximate to the plurality of blades extending from the rotatable body and are nonparallel with the plurality of blades extending from the rotatable body.

2. The seal of claim 1, wherein the plurality of blades extending radially from the stationary body are generally orthogonal to the plurality of blades extending from the rotatable body.

3. The seal of claim 1, wherein the plurality of blades extending radially from the rotatable body are aligned at an angle of between about 1 degree and about 89 degrees relative to a rotational axis of the rotatable body.

4. The seal of claim 3, wherein the plurality of blades extending radially from the rotatable body are aligned at an angle of about 60 degrees relative to a rotational axis of the rotatable body.

5. The seal of claim 1, wherein the plurality of blades extending radially from the stationary body are aligned at an angle of between about 1 degree and about 89 degrees relative to a rotational axis of the rotatable body.

6. The seal of claim 5, wherein the plurality of blades extending radially from the stationary body are aligned at an angle of about 60 degrees relative to a rotational axis of the rotatable body.

7. The seal of claim 1, wherein the plurality of blades extending radially from the rotatable body forms a plurality of rows of blades.

8. The seal of claim 1, wherein the plurality of blades extending radially from the stationary body forms a plurality of rows of blades.

9. The seal of claim 1, wherein the plurality of blades extending radially from the rotatable body extend to within about 0.6 millimeters radially from the stationary body.

10. The seal of claim 1, wherein the plurality of blades extending radially from the stationary body extend to within about 0.6 millimeters radially from the rotatable body.

11. A seal, comprising:
a plurality of blades extending radially from a rotatable body and positioned generally nonparallel to a rotational axis of the rotatable body, wherein the plurality of blades generally form at least one row of blades;
a plurality of blades extending radially from a stationary body towards the rotatable body and positioned nonparallel to the rotational axis of the rotatable body, wherein the plurality of blades form at least one row of blades; and
wherein the plurality of blades extending radially from a stationary body are positioned proximate to the plurality of blades extending from the rotatable body and are nonparallel with the plurality of blades extending from the rotatable body.

12. The seal of claim 11, wherein the plurality of blades extending radially from the stationary body are generally orthogonal to the plurality of blades extending from the rotatable body.

13. The seal of claim 11, wherein the plurality of blades extending radially from the rotatable body are aligned at an angle of between about 1 degree and about 89 degrees relative to a rotational axis of the rotatable body.

14. The seal of claim 13, wherein the plurality of blades extending radially from the rotatable body are aligned at an angle of about 60 degrees relative to a rotational axis of the rotatable body.

15. The seal of claim 11, wherein the plurality of blades extending radially from the stationary body are aligned at an angle of between about 1 degree and about 89 degrees relative to a rotational axis of the rotatable body.

16. The seal of claim 15, wherein the plurality of blades extending radially from the stationary body are aligned at an angle of about 60 degrees relative to a rotational axis of the rotatable body.

17. The seal of claim 11, wherein the plurality of blades extending radially from the rotatable body forms a plurality of rows of blades.

18. The seal of claim 11, wherein the plurality of blades extending radially from the stationary body forms a plurality of rows of blades.

19. The seal of claim 11, wherein the plurality of blades extending radially from the rotatable body extend to within about 0.6 millimeters radially from the stationary body.

20. The seal of claim 11, wherein the plurality of blades extending radially from the stationary body extend to within about 0.6 millimeters radially from the rotatable body.
